(19) United States
(12) Patent Application Publication
(10) Pub. No.: US 2014/0016630 A1
(43) Pub. Date: Jan. 16, 2014

(54) COMMUNICATION DEVICE, COMMUNICATION SYSTEM AND COMMUNICATION METHOD

(71) Applicant: Buffalo Inc., Nagoya-shi (JP)

(72) Inventor: Akira ONO, Nagoya-shi (JP)

(21) Appl. No.: 13/919,471

(22) Filed: Jun. 17, 2013

(30) Foreign Application Priority Data
Jul. 13, 2012 (JP) 2012-157361

(51) Int. Cl. H04W 36/24

(52) U.S. Cl. CPC H04W 36/24
USPC 370/338

(57) ABSTRACT

A communication device including an electric charger configured to perform a power supply operation with another device located at a shorter distance than a coverage distance of wireless communication by a first communication system, the power supply operation including providing a power supply to, or receiving a power supply from, the another device. The communication device starts preparation for wireless communication by a second communication system, which has a larger coverage distance than the coverage distance of wireless communication by the first communication system, when a currently-active power supply operation is interrupted during selection of the first communication system for wireless communication with the another device. The communication device then starts wireless communication by the second communication system, in place of the first communication system, based on the preparation for wireless communication by the second communication system.

### TECHNICAL FIELD

The present disclosure relates to reducing interruptions when switching between communication systems.

### BACKGROUND ART

In a wireless communication terminal that is capable of selecting one of a plurality of different communication systems, one proposed technique selects a communication system based on the state of charge in a battery (for example, JP 2007-181178A). Another proposed technique for selection of the communication system starts a preparation for switchover to wireless communication by another communication system, based on reduction of the signal intensity of wireless communication as the trigger.

### SUMMARY

The former proposed technique, however, has the problem of a relatively long recovery time (time when wireless communication is interrupted) to resume wireless communication by another system when wireless communication is interrupted. The latter technique of selecting the communication system based on the signal intensity shortens the time when communication is interrupted by the time interval between reduction of the signal intensity and actual communications blackout and ideally prevents communications blackout. The shorter time interval, however, leads to reduction of the effect of shortening the time when communication is interrupted. This accordingly results in insufficient improvement in shortening the time when communication is interrupted. Especially communication using radio wave in a high frequency band for the purpose of high-speed wireless communication tends to have the shorter time interval and is thus significantly affected by this problem.

There is accordingly a need to reduce or prevent interruption of wireless communication.

According to one aspect of the invention, there is provided a communication device, which includes an electric charger configured to perform a power supply operation with another device located at a shorter distance than a coverage distance of wireless communication by a first communication system, the power supply operation including providing a power supply to, or receiving a power supply from, the another device. The communication device starts preparation for wireless communication by a second communication system, which has a larger coverage distance than the coverage distance of wireless communication by the first communication system, when a currently-active power supply operation is interrupted during selection of the first communication system for wireless communication with the another device. The communication device then starts wireless communication by the second communication system, in place of the first communication system, based on the preparation for wireless communication by the second communication system.

### BRIEF DESCRIPTION OF DRAWINGS

FIG. 1 is a diagram illustrating the schematic configuration of a communication system;

FIG. 2 is a block diagram illustrating the configuration of a cradle;

FIG. 3 is a block diagram illustrating the configuration of an access point;

FIG. 4 is a flowchart showing a communication system selection process;

FIG. 5 is a flowchart showing a first low-speed communication system selection process;

FIG. 6 is a flowchart showing a second low-speed communication system selection process;

FIG. 7 is a diagram illustrating one example of selection of communication system;

FIG. 8 is a block diagram illustrating the configuration of an access point according to Embodiment 2; and

FIG. 9 is a block diagram illustrating the configuration of a communication device according to Embodiment 3.

### DESCRIPTION OF EMBODIMENTS

### Embodiment 1

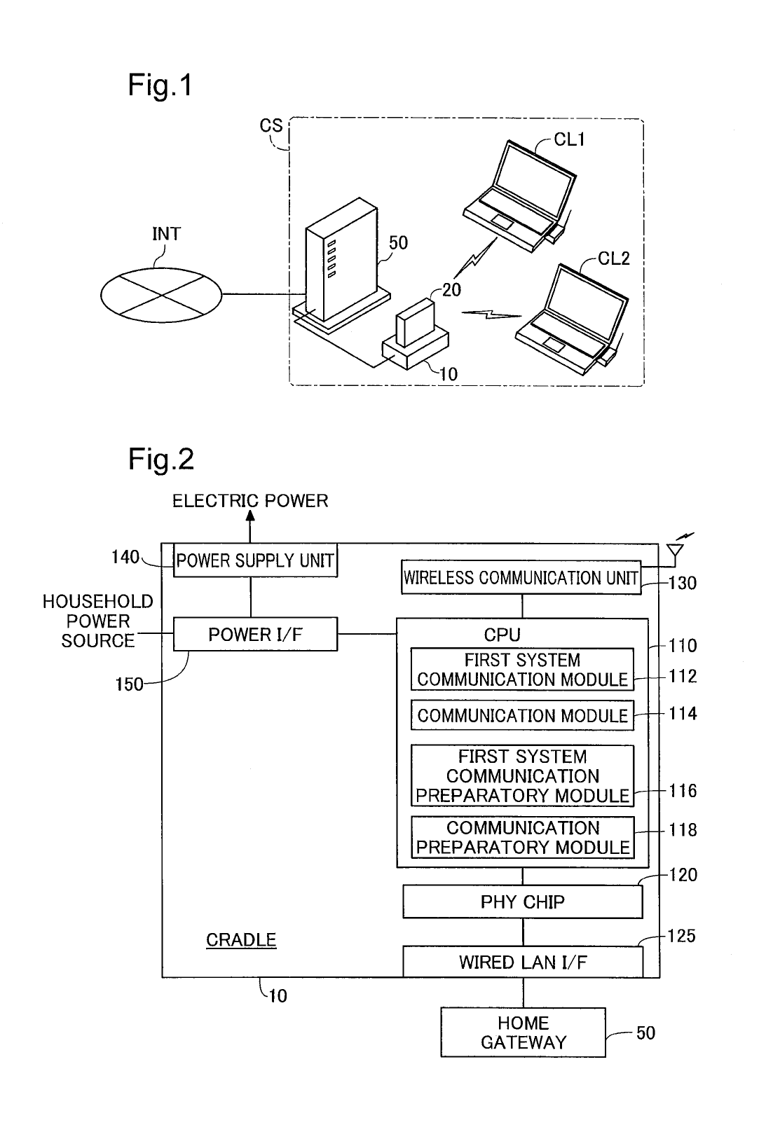

### Communication System CS (FIG. 1);

FIG. 1 illustrates the schematic configuration of a communication system CS. As illustrated in FIG. 1, the communication system CS includes a cradle 10, an access point 20 for wireless LAN and a home gateway 50. The communication system CS connects client devices to a WAN, i.e., the Internet INT according to this embodiment. The cradle 10 has wireless power supply function to wirelessly supply electric power to the access point 20. The home gateway 50 relays communication between the client devices and the Internet INT. According to this embodiment, the client devices are known computers having the functions of wireless LAN client devices. In the illustrated example of FIG. 1, personal computers are client devices CL1 and CL2. The client devices may also include, for example, game machines, smartphones, PDAs and other access points.

The home gateway 50 serves as a broadband router. The cradle 10 is connected with the home gateway 50 by wire. The access point 20 makes wireless communication with the cradle 10 and the client devices CL1 and CL2 and relays wireless communication between the cradle 10 and the client devices CL1 and CL2. In the illustrated state of FIG. 1, the access point 20 is placed on the cradle 10. Locating the access point 20 near to the cradle 10 in this way enables efficient wireless power supply from the cradle 10 to the access point 20 as described later.

### Cradle 10 (FIG. 2):

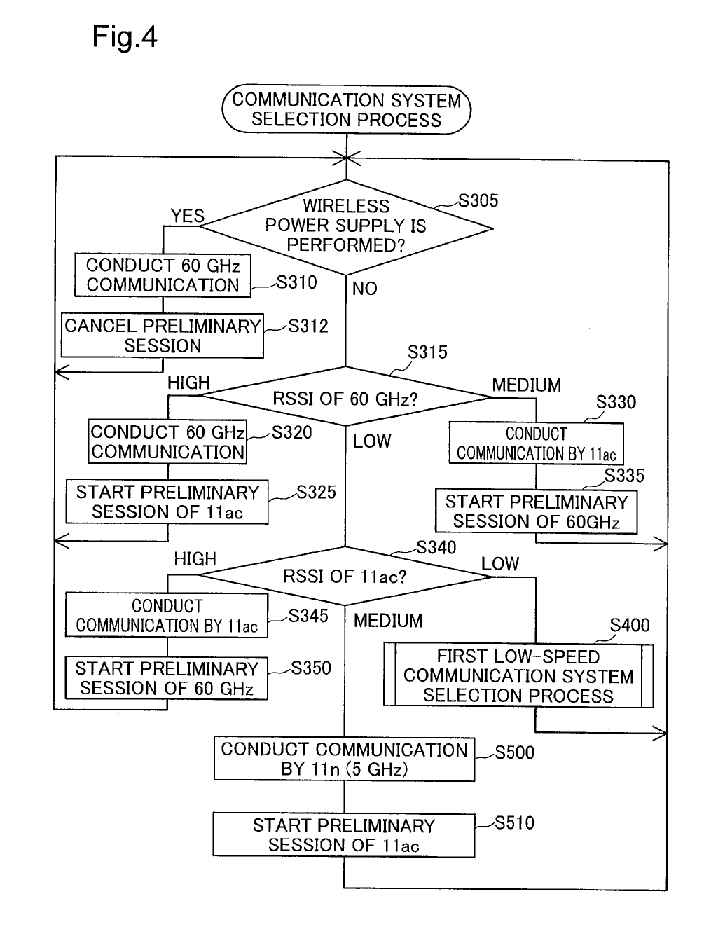

FIG. 2 is a block diagram illustrating the configuration of the cradle 10. As illustrated in FIG. 2, the cradle 10 includes a CPU 110, a PHY chip 120, a wired LAN I/F 125, a wireless communication unit 130, a power supply unit 140 and a power I/F 150. The power supply unit 140 is one example of an electric charger. The CPU 110 performs a communication system selection process (described later with reference to FIG. 4) to serve as a first system communication module 112, a communication module 114, a first system communication preparatory module 116 and a communication preparatory module 118.

The wireless communication unit 130 receives and sends radio waves for wireless communication. The wireless communication unit 130 includes at least a modulator, an amplifier and an antenna. The wireless communication unit 130 is controlled by the CPU 110. The wireless communication unit 130 is arranged to be available for a plurality of different wireless communication systems. The plurality of wireless communication systems include a system using the 60 GHz band (milliwave) (hereinafter communication by this system is called “60 GHz communication”) and a plurality of wireless communication standards conforming to IEEE802.11 standard. The plurality of wireless communication standards conforming to IEEE802.11 standard are IEEE802.11, IEEE802.11a, IEEE802.11b, IEEE802.11g, IEEE802.11n, and IEEE802.11ac according to this embodiment. In the description hereafter, the former part “IEEE802.” is omitted from the expressions of such wireless communication standards. More specifically, 11a represents the wireless communication standard using radio waves of the 5 GHz band; 11, 11b and 11g represent the wireless communication standards using radio waves of the 2.4 GHz band; and 11n represents the wireless communication standard using either radio waves of the 2.4 GHz band or 5 GHz band.

The wired LAN I/F 125 serves as an interface for wired communication with the home gateway 50. The cradle 10 communicates with the home gateway 50 via a wired LAN conforming to IEEE802.3 communication standard. The PHY chip 120 serves as an interface between the wired LAN I/F 125 and the CPU 110. The PHY chip 120 makes conversion between logical signals and actual electrical signals. The power I/F 150 supplies electric power from a household power source to the CPU 110 and the power supply unit 140. The power supply unit 140 performs wireless power supply. According to this embodiment, electromagnetic induction method is adopted for the wireless power supply. The power supply unit 140 includes at least a coil for causing electromagnetic induction. The shorter distance between the power supply unit and the power-receiving unit allows the higher efficiency of wireless power supply by the electromagnetic induction method. In order to ensure the effective power supply to a device subjected to power supply, it is accordingly preferable that the distance between the power supply unit 140 and the power-receiving unit of the device subjected to power supply is equal to or less than a specified value. There is no substantial power supply, on the other hand, when the distance between the power supply unit 140 and the power-receiving unit of the device subjected to power supply exceeds the specified value. This specified value is less than the maximum of the coverage distance for the 60 GHz communication.

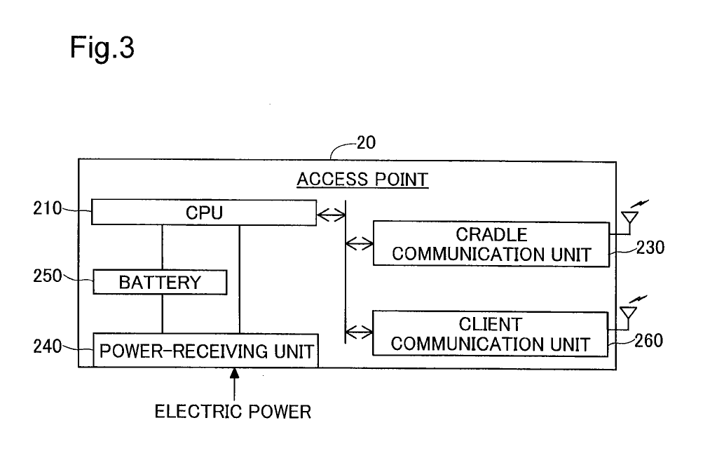

### Access Point 20 (FIG. 3):

FIG. 3 is a block diagram illustrating the configuration of the access point 20. The access point 20 includes a CPU 210, a cradle communication unit 230, a power-receiving unit 240, a battery 250 and a client communication unit 260. The power-receiving unit 240 receives wireless power supply by the electromagnetic induction method. The power-receiving unit 240 supplies the electric power received by wireless power supply to the CPU 210 and the battery 250. The cradle communication unit 230 selects one communication system among a plurality of different communication systems to establish wireless communication with the cradle 10. The plurality of communication systems are identical with the communication systems selectable by the cradle 10. The cradle communication unit 230 includes at least a modulator, an amplifier and an antenna. The CPU 210 controls the cradle communication unit 230 and the client communication unit 260 to relay wireless communication between the cradle 10 and the client device.

### Communication System Selection Process (FIG. 4):

FIG. 4 is a flowchart showing the communication system selection process. This process is triggered by a start of communication between the cradle 10 and the access point 20. The communication herein means wireless communication between the cradle 10 serving as an access point of the IEEE802.11 wireless communication standard and the access point 20 as a station of the IEEE802.11 wireless communication standard. In this communication, the client communication unit 260 included in the access point 20 makes a LAN connection, and the cradle communication unit 230 makes a WAN connection. The start of communication is detected in response to a received beacon. Which communication system is to be selected on the start of communication may be determined arbitrarily by a known technique.

On the start of the communication system selection process, the CPU 110 first determines whether or not wireless power supply is performed (step S305). This determination is based on the following criterion: during charging of the battery 250 included in the access point 20, it is determined that wireless power supply is performed and during discharging of the battery 250, it is determined that wireless power supply is not performed. Information with regard to charging or discharging of the battery 250 is obtained by wireless communication from the access point 20.

When it is determined that wireless power supply is performed (step S305: YES), the first system communication module 112 of the CPU 110 conducts 60 GHz communication (step S310). The expression of “conduct 60 GHz communication” means continuing the 60 GHz communication when the 60 GHz communication is currently active, but means starting 60 GHz communication as it becomes available when the 60 GHz communication is currently inactive. The case where the 60 GHz communication is currently inactive may be either the case where wireless communication by another communication system is currently active or the case where any wireless communication by any communication system is currently inactive. When wireless communication by another communication system is currently active, this process switches over the communication system to the 60 GHz communication with interrupting the wireless communication by another communication system. This procedure with respect to conduction of communication is similarly applicable to conduction of communication by another communication system.

The CPU 110 subsequently cancels a preliminary session (step S312) and returns the processing to step S305. The preliminary session will be described below with respect to step S325. When there is no preliminary session, the CPU 110 does nothing at step S312.

When it is determined that wireless power supply is not performed (step S305: NO), on the other hand, the CPU 110 determines the level of the RSSI (received signal strength indication) of 60 GHz communication (step S315). More specifically, the CPU 110 obtains the RSSI value of 60 GHz communication from the access point 20 by wireless communication and compares the obtained RSSI value with two predetermined reference values to classify the obtained RSSI value into one of three levels “HIGH”, “MEDIUM” and “LOW”. According to this embodiment, the RSSI value is obtained by using beacon. The procedure with respect to determination of the RSSI is similarly applicable to determination of the RSSI by another communication system.

When the RSSI of the 60 GHz communication is determined as the high level (step S315: HIGH), the first system communication module 112 of the CPU 110 conducts 60 GHz communication (step S320). The communication preparatory module 118 of the CPU 110 subsequently starts establishment of a preliminary session of 11ac (step S325) and returns the processing to step S305. The establishment of a preliminary session of 11ac makes standby for starting communication by 11ac in a short time. More specifically, the cradle 10, in cooperation with the client device and the home gateway 50, performs at least part of a series of authentication operations for starting communication. According to this embodiment, the cradle 10 obtains a communication frequency (channel) used for wireless communication with the access point 20, an encryption system and an encryption key and performs at least one of a connection request and an authentication request to enable a start of communication with the access point. Starting the establishment of a preliminary session serves as a trigger to start this series of operations. When a preliminary session of 11ac has already been established, the process keeps the preliminary session of 11ac at step S325. When it is in the middle of establishing a preliminary session of 11ac, the process continues the operation for establishing a preliminary session of 11ac at step S325. The procedure with respect to establishment of a preliminary session in the state of high RSSI is similarly applicable to establishment of a preliminary session in the state of high RSSI by another communication system.

Establishment of a preliminary session of 11ac is started irrespective of the high RSSI of the 60 GHz communication, because the failed wireless power supply increases the potential for abrupt interruption of communication. The failed wireless power supply suggests that the access point 20 is not located near to the cradle 10. There is, however, the case of failed wireless power supply even when the access point 20 is located near to the cradle 10. This is, for example, the case that the secondary battery is in the state of full charge.

When the RSSI of the 60 GHz communication is determined as the medium level (step S315: MEDIUM), on the other hand, the communication module 114 of the CPU 110 conducts communication by 11ac (step S330). For conduction of communication, when there is a preliminary session of 11ac that has already been established or that is being established, communication is started by utilizing this preliminary session. The first system communication preparatory module 116 of the CPU 110 subsequently starts establishment of a preliminary session of 60 GHz communication (step S335) and returns the processing to step S305. When the RSSI is determined as the medium level at step S315 during the 60 GHz communication, the first system communication preparatory module 116 of the CPU 110 utilizes this currently active 60 GHz communication to keep the state ready for restarting the communication. During the 60 GHz communication, the CPU 110 keeps the preliminary session of 60 GHz communication. The procedure with respect to establishment of a preliminary session in the state of medium RSSI is similarly applicable to establishment of a preliminary session in the state of medium RSSI by another communication system.

When the RSSI of the 60 GHz communication is determined as the low level (step S315: LOW), on the other hand, the CPU 110 subsequently determines the level of the RSSI of 11ac (step S340). When at least one of the cradle 10 and the access point 20 is not compatible with 11ac, the CPU 110 determines the RSSI of 11ac as the low level. When the CPU 110 is not informed of the fact that the cradle 10 is compatible with 11ac but the access point 20 is not compatible with 11ac, the CPU 110 recognizes the incapability of communication with the access point 20 by 11ac by determining the level of the RSSI of 11ac. As the result of recognition of the incapability of communication by 11ac, the CPU 110 determines the RSSI of 11ac as the low level.

When the RSSI of 11ac is determined as the high level (step S340: HIGH), the CPU 110 conducts communication by 11ac (step S345). The CPU 110 subsequently starts establishment of a preliminary session of 60 GHz communication (step S350) and returns the processing to step S305. The 60 GHz communication is selected as the communication system for establishing a preliminary session irrespective of the low RSSI of the 60 GHz communication, since the high RSSI of 11ac reduces the possibility of abrupt interruption of wireless communication by 11ac and makes it possible to be connected by 60 GHz communication that allows higher-speed wireless communication. Not the easily connectable communication system but the 60 GHz communication as the higher-speed communication system is accordingly adopted as the communication system for establishing a preliminary session. In the specification hereof, the expression of “communication is not interrupted” should not be interpreted in the strict sense but also means that communication is continued substantially in the same manner as no-interruption of communication.

When the RSSI of 11ac is determined as the medium level (step S340: MEDIUM), the CPU 110 conducts communication by 11n (5 GHz) (step S500). Communication by 11n is conducted without determining the level of the RSSI of 11n, since the medium RSSI of 11ac increases the possibility that 11n (5 GHz) using the close frequency band has also the medium or higher level of RSSI. The CPU 110 then starts establishment of a preliminary session of 11ac and returns the processing to step S305.

When the RSSI of 11ac is determined as the low level (step S340: LOW), the CPU 110 performs a first low-speed communication system selection process (step S400) and returns the processing to step S305. A preliminary session of 11ac is not established in this case, since the low RSSI is insufficient for wireless communication by 11ac and accordingly reduces the possibility that a preliminary session is utilized even after establishment. The above series of processing is repeated, while the session between the cradle 10 and the access point 20 is maintained.

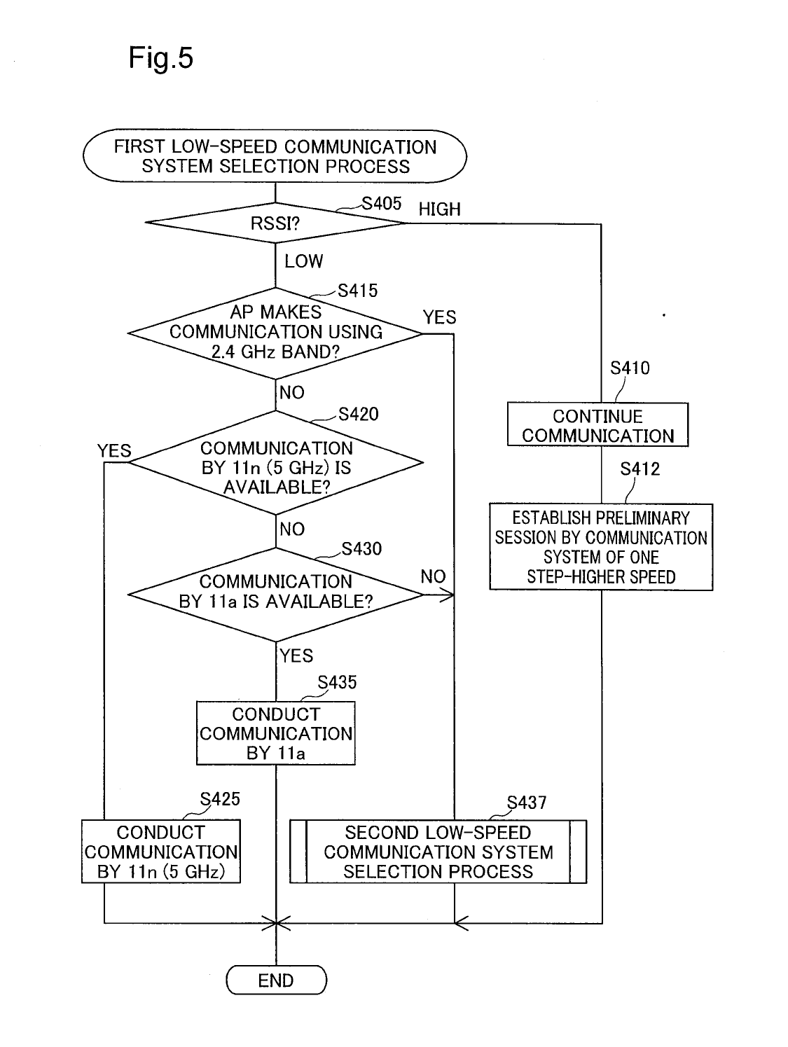

### First Low-Speed Communication System Selection Process (FIG. 5):

FIG. 5 is a flowchart showing the details of the first low-speed communication system selection process performed at step S400 described above. On the start of the first low-speed communication system selection process, the CPU 110 determines the level of the RSSI (hereinafter referred to as “currently-active RSSI”) of the communication system currently used for wireless communication (hereinafter referred to as “currently-active communication system”) (step S405). The level determination is based on the comparison between the RSSI value and a predetermined reference value. Different reference values may be used for the individual communication systems, or the same reference value may be used for all the communication systems. In the event of communications blackout, the “RSSI” is determined as the “low level”. When the RSSI is determined as the high level (step S405: HIGH), the CPU 110 continues wireless communication by the currently-active communication system (step S410), starts establishment of a preliminary session by a communication system of one step-higher speed (step S412), and then terminates the first low-speed communication system selection process. The communication system of one step-higher speed is 11ac when the currently-active communication system is 11n (5 GHz), and is 11n when the currently-active communication system is 11a. In the state of the high level of the currently-active RSSI, there is a high possibility that the currently-active communication system is switched over not to a communication system of one step-lower speed but to a communication system of one step-higher speed. The communication system of one step-lower speed is defined by the reverse relationship to that of the communication system of one step-higher speed. Advanced establishment of a preliminary session of the communication system of one step-higher speed enables the switchover of the communication system to be completed within a shorter time.

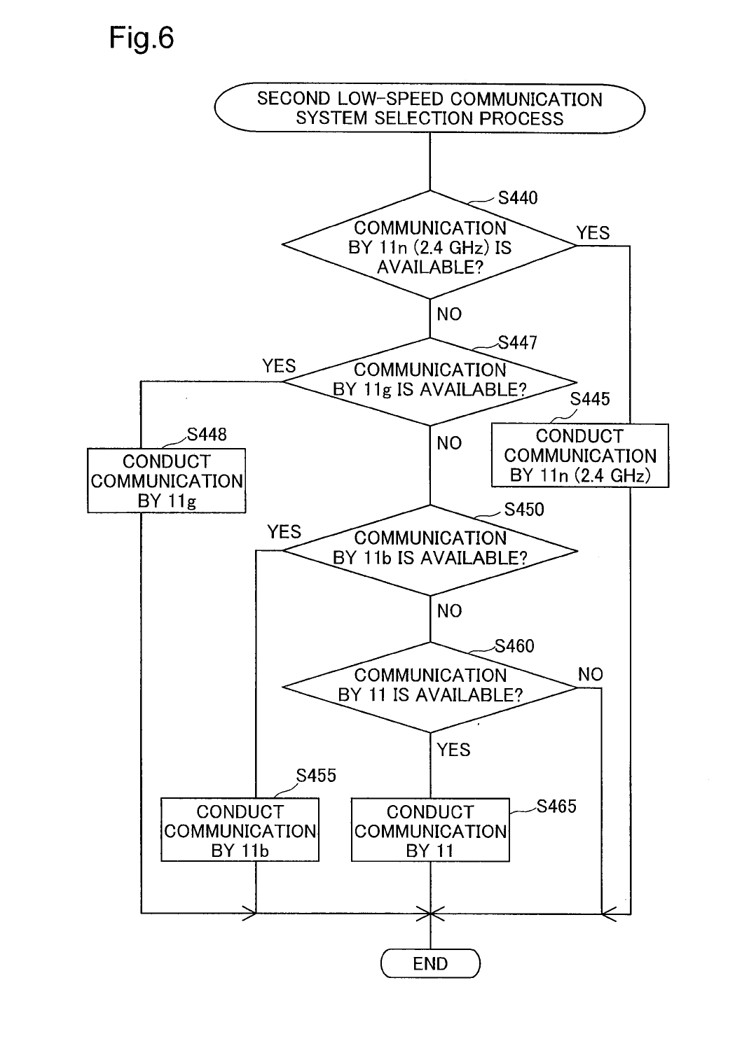

When the RSSI is determined as the low level (step S405: LOW), on the other hand, the CPU 110 subsequently determines whether or not the access point 20 currently makes communication with the client device by the communication system in the 2.4 GHz frequency band (step S415). When it is determined that the access point 20 currently does not make communication with the client device by the communication system in the 2.4 GHz frequency band (step S415: NO), the CPU 110 performs operations to make communication using the 5 GHz frequency band. More specifically, the CPU 110 determines whether communication by 11n (5 GHz) is available (step S420). The availability of communication may be determined based on the RSSI value or the frequency of communication error. More specifically, the communication is determined available when the RSSI value is equal to or greater than a predetermined reference value or when the frequency of communication error is equal to or less than a predetermined reference level. The RSSI value or the frequency of communication error may be obtained by wireless communication with the access point 20. The determination of the communication availability is similarly applicable to determination of the availability of another communication system in the first low-speed communication system selection process and in a second low-speed communication system selection process (described later in detail with reference to FIG. 6).

When communication by 11n (5 GHz) is determined available (step S420: YES), the CPU 110 conducts communication by 11n (5 GHz) (step S425) and then terminates the first low-speed communication system selection process. Although not being specifically illustrated in FIG. 5, in the state of low RSSI of wireless communication by 11n (5 GHz), the process may start establishment of a preliminary session of 11a at step S425. In the state of the low level of the currently-active RSSI, there is a high possibility that the currently-active communication system is switched over not to a communication system of one step-higher speed but to a communication system of one step-lower speed. Advanced establishment of a preliminary session of the communication system of one step-lower speed enables the switchover of the communication system to be completed within a shorter time.

When communication by 11n (5 GHz) is determined unavailable (step S420: NO), on the other hand, the CPU 110 subsequently determines whether communication by 11a is available (step S430). As described previously, 11a represents the communication system using the 5 GHz frequency band. When communication by 11a is determined available (step S430: YES), the CPU 110 conducts communication by 11a (step S435) and then terminates the first low-speed communication system selection process.

When communication by 11a is determined unavailable (step S430: NO) or when it is determined that the access point 20 currently makes communication with the client device by the communication system in the 2.4 GHz frequency band (step S415: YES), the CPU 110 performs a second low-speed communication system selection process (step S437) and then terminates the first low-speed communication system selection process.

### Second Low-Speed Communication System Selection Process (FIG. 6):

FIG. 6 is a flowchart showing the details of the second low-speed communication system selection process. The second low-speed communication system selection process is performed to make communication using the 2.4 GHz frequency band. The CPU 110 first determines whether communication by 11n using the 2.4 GHz frequency band is available (step S440). When communication by 11n using the 2.4 GHz frequency band is determined available (step S440: YES), the CPU 110 conducts communication by 11n using the 2.4 GHz frequency band (step S445) and then terminates the second low-speed communication system selection process.

When communication by 11n using the 2.4 GHz frequency band is determined unavailable (step S440: NO), on the other hand, the CPU 110 subsequently determines whether communication by 11g is available (step S447). When communication by 11g is determined available (step S447: YES), the CPU 110 conducts communication by 11g (step S448) and then terminates the second low-speed communication system selection process. When communication by 11g is determined unavailable (step S447: NO), on the other hand, the CPU 110 subsequently determines whether communication by lib is available (step S450). When communication by lib is determined available (step S450: YES), the CPU 110 conducts communication by lib (step S455) and then terminates the second low-speed communication system selection process. When communication by 11b is determined unavailable (step S450: NO), on the other hand, the CPU 110 subsequently determines whether communication by 11 is available (step S460). When communication by 11 is determined available (step S460: YES), the CPU 110 conducts communication by 11 (step S465) and then terminates the second low-speed communication system selection process.

Like the first low-speed communication system selection process, the second low-speed communication system selection process may start establishment of a preliminary session of a communication system of one step-higher speed in the state of the high level of the currently-active RSSI, and may start establishment of a preliminary session of a communication system of one step-lower speed in the state of the low level of the currently-active RSSI. Selection of a communication system expected to be used after the switchover according to the currently-active RSSI and advanced establishment of a preliminary session of the selected communication system enables the switchover of the communication system to be completed within a shorter time. The communication system of one step-higher speed in the 2.4 GHz frequency band is 11n (2.4 GHz) when the currently-active communication system is 11g, is 11g when the currently-active communication system is 11b, and is 11b when the currently-active communication system is 11.

When communication by 11 is determined unavailable (step S460: NO), on the other hand, the CPU 110 terminates the second low-speed communication system selection process. In this case, the interrupted state of communication continues.

As mentioned above, all 11ac, 11n, 11a, 11g, 11b and 11 are wireless communication standards. A plurality of communication speeds are specified as link speeds for each of these wireless communication standards. The communication system set at the adequate link speed in the set wireless communication standard is conducted in conformity to the wireless communication standard.

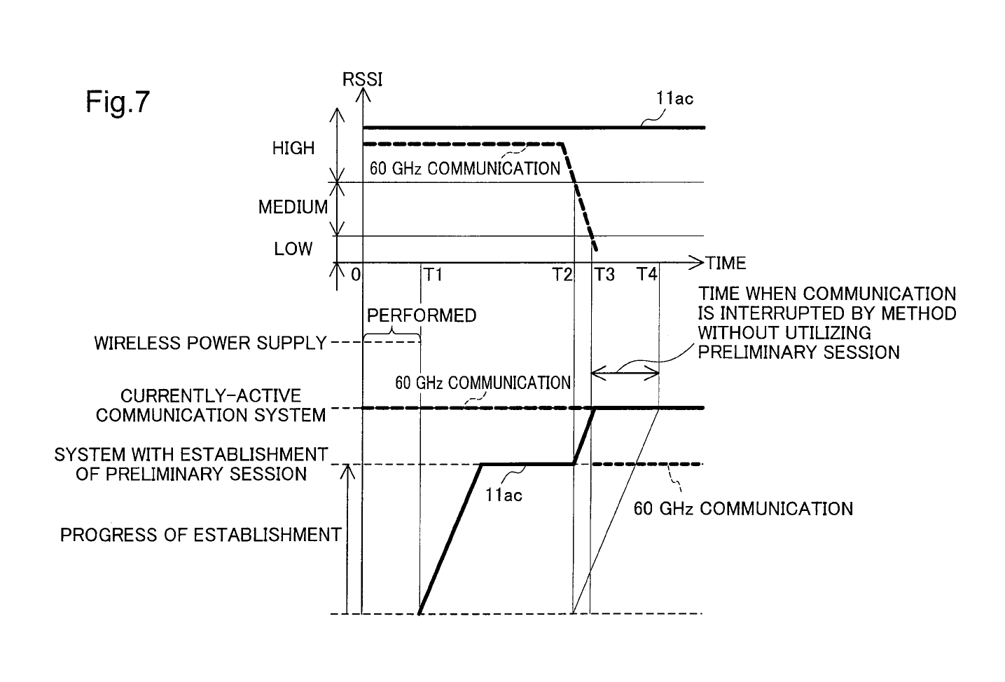

### Example of Selection of Communication System (FIG. 7):

FIG. 7 schematically illustrates one example of selection of communication system. In the illustrated example of FIG. 7, it is assumed that the access point 20 placed on the cradle 10 is moved away from the cradle 10 at a constant speed. FIG. 7 shows changes of subjects with an increase in distance of the access point 20 from the cradle 10 converted to the changes of the subjects with time. The subjects here include the RSSI, whether or not wireless power supply is performed, which communication system is currently active to conduct communication, for which communication system a preliminary session is established, and the progress of establishment of the preliminary session. The communication systems illustrated in FIG. 7 are only the 60 GHz communication and communication by 11ac.

In FIG. 7, in a time period between time 0 and time T1, since there is a short distance between the cradle 10 and the access point 20, wireless power supply to the access point 20 is performed. During this time period, the processing of steps S310 and S312 in the communication system selection process is accordingly repeated. As a result, the 60 GHz communication is selected as the communication system, and no preliminary session is established.

Since the access point 20 is moved away from the cradle 20 at a constant speed, wireless power supply is suspended after the time T1 as shown in FIG. 7. The RSSI of the 60 MHz communication is the high level at the time T1. The processing of steps S320 and S325 is accordingly repeated after the time T1. As a result, establishment of a preliminary session of 11ac is started at the time T1. The communication system remains as the 60 GHz communication.

Since the access point 20 is moved away from the cradle 20 at a constant speed, the RSSI of the 60 GHz communication is reduced from the high level to the medium level at time T2 as shown in FIG. 7. The processing of steps S330 and S335 is accordingly repeated after the time T2. The preliminary session of 11ac has already been established by the time T2 as shown in FIG. 7, so that the communication starts using this preliminary session. The communication by 11ac is, however, not enabled to start at the time T2. The communication system remains as the 60 GHz communication until the communication by 11ac is enabled.

As shown in FIG. 7, the RSSI of the 60 GHz communication is further reduced from the medium level to the low level at time T3, while the RSSI of 11ac is kept at the high level. The processing of steps S345 and S350 is accordingly repeated after the time T3. The low RSSI causes difficulty in making normal communication. At substantially the same time as the time T3, the communication by 11ac is enabled as shown in FIG. 7. The communication between the cradle 10 and the access point 20 is thus substantially continued without communications blackout.

In the switchover of the communication system from the 60 GHz communication to 11ac, the prior art method starts communication by 11ac without utilizing a preliminary session. When the switchover starts at the time T2, for example, communication by 11ac is enabled at time T4 as shown in FIG. 7. In this case, it is likely to interrupt communication in the period between the time T3 and the time T4.

### Advantageous Effects:

The process of this embodiment at least shortens the time when communication is interrupted or ideally prevents communications blackout, while selecting the higher-speed communication system. Especially, this embodiment reduces the possibility of interruption of communication during the 60 GHz communication. The 60 GHz communication uses the high frequency band and is thus likely to abruptly reduce its RSSI level when the access points 20 is distant away from the cradle 10 or when there is any obstacle between the access point 20 and the cradle 10. By the technique of monitoring the RSSI, it is likely to cause interruption of communication before establishment of a preliminary session of another communication system. According to this embodiment, on the other hand, establishment of a preliminary session of 11ac is triggered by failed wireless power supply. It is accordingly highly possible to establish a preliminary session of 11ac at the stage where the RSSI of the 60 GHz communication is still the relatively high level. Additionally, for the purpose of increasing this possibility, this embodiment does not require to continually establish a preliminary session of 11ac. Continual establishment of the preliminary session of 11ac is undesirable, since it may cause additional power consumption and additional occupancy of the communication band.

The communication system 11ac also allows high-speed communication and is thus specified as the subject for establishment of a preliminary session, while the use frequency of 11ac is enhanced by the processing of steps S510 and S520. In the case of conducting communication by a communication system other than 60 GHz communication or 11ac, interruption of communication is minimized by adequately changing the communication system according to the RSSI.

### Embodiment 2

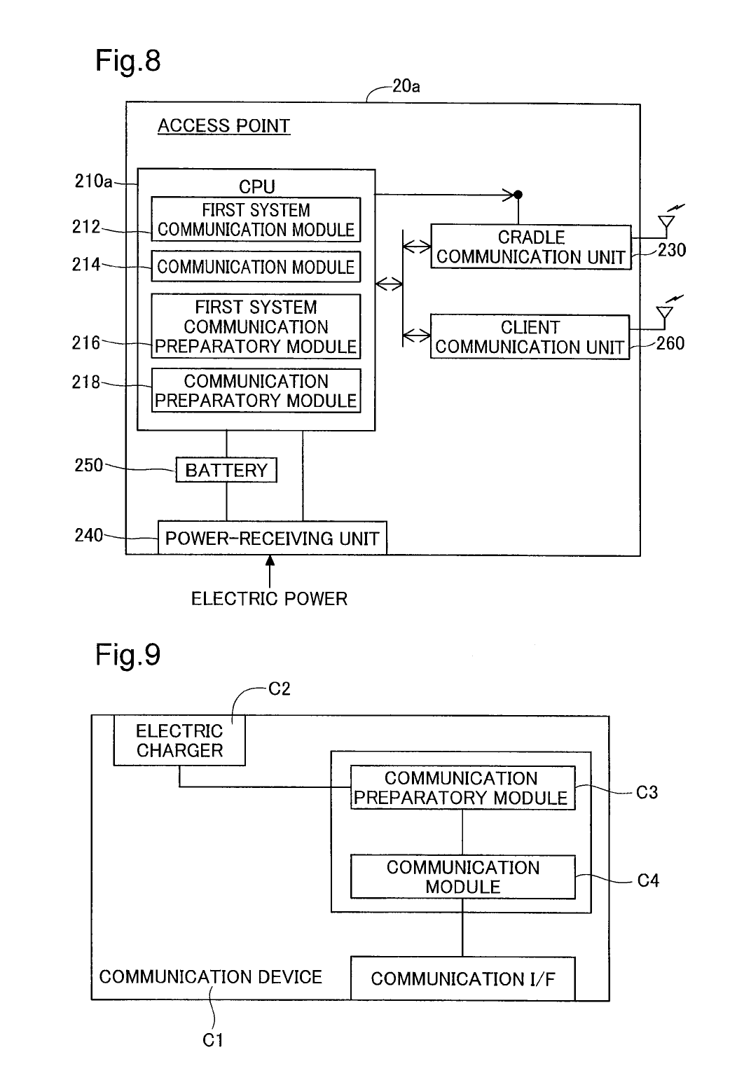

The description of Embodiment 2 only regards the differences from Embodiment 1. FIG. 8 is a block diagram illustrating the configuration of an access point 20a according to Embodiment 2. The access point 20a is used in place of the access point 20 of Embodiment 1.

The primary difference of the access point 20a from the access point 20 is that the access point 20a mainly performs the communication system selection process instead of the cradle 10. The access point 20a has a CPU 210a, in place of the CPU 210, to perform the communication system selection process. The CPU 210a performs the communication system selection process of Embodiment 2 to serve as a first system communication module 212, a communication module 214, a first system communication preparatory module 216 and a communication preparatory module 218. A power-receiving unit 240 of Embodiment 2 is one example of an electric charger.

The communication system selection process of Embodiment 2 is substantially similar to the communication system selection process of Embodiment 1. The primary difference of the communication system selection process of Embodiment 2 from the communication system selection process of Embodiment 1 is no requirement of obtaining information as the bases of detection of starting communication, determination of whether wireless power supply is performed (step S305) and determination of the RSSI level (e.g., steps S315, S340 and S405), by communication.

The CPU included in a cradle of Embodiment 2 does not perform the communication system selection process and accordingly does not serve as the first system communication module, the communication module, the first system communication preparatory module or the communication preparatory module.

### Embodiment 3

FIG. 9 is a block diagram illustrating the configuration of a communication device C1 according to Embodiment 3. The communication device C1 includes an electric charger C2, a communication preparatory module C3 and a communication module C4. The electric charger C2 is configured to enable power supply and power reception to and from other device located in a shorter distance than the coverage distance of wireless communication by a first communication system. The communication preparatory module C3 is configured to monitor the status of currently active power supply or power reception of the electric charger C2 with the other device when the first communication system is selected as the system of wireless communication with the other device. When detecting interruption of the currently active power supply or power reception of the electric charger C2 with the other device, the communication preparatory module C3 starts preparation for wireless communication by a second communication system with the other device via the communication module C4. In other words, the communication preparatory module C3 starts preparation of wireless communication by the second system, not based on the monitoring result of the signal intensity of wireless communication by the first system but based on whether power supply or power reception of the electric charger is enabled. The coverage distance of wireless communication by the second communication system is longer than the coverage distance of wireless communication by the first communication system.

When the wireless communication conditions by the first communication system do not satisfy specified conditions, the communication module C4 starts wireless communication by the second communication system, in place of the first communication system, by utilizing the preparation by the communication preparatory module C3. Utilizing the preparation means using wireless communication by the second communication system that has been completely prepared by the communication preparatory module C3 or using wireless communication by the second communication system that is still under preparation by the communication preparatory module C3. Using wireless communication by the second communication system that has not yet been completely prepared but is still under preparation advantageously shortens the time required to start wireless communication by the second communication system, compared with the method of starting wireless communication by the second communication system based on dissatisfaction of the specified conditions as the trigger.

According to the third embodiment, the location of the other device that enables power supply or power reception is the coverage distance of wireless communication by the first system. The third embodiment thus enables preparation of wireless communication by the second system to start while the wireless communication by the first system is still enabled. In other words, this increases the possibility of starting a preparation of wireless communication by the second system, before the signal intensity of wireless communication by the first system is abruptly reduced. Starting wireless communication by the second system by utilizing such preparation is likely to shorten the time when communication is interrupted. Additionally, this method starts the preparation based on interruption of power supply or power reception as the trigger and accordingly saves power, compared with the method of continually making such preparation.

### Other Embodiments

The disclosure is not limited to the embodiments described above but may be implemented by any of various other embodiments in the scope of the disclosure. For example, the technical features of the embodiments corresponding to the technical features of the respective aspects described in SUMMARY may be replaced or combined adequately, in order to solve part or all of the foregoing problems or in order to achieve part or all of the foregoing advantageous effects. The technical features may be omitted adequately unless specified essential. Some examples of other possible embodiments are described below.

Establishment of a preliminary session may be performed in a different mode from those of the embodiments, as long as the mode contributes to shortening the switchover time of the communication system. For example, establishment of a preliminary session may be until notification of a client device of starting an authentication protocol. In another example, establishment of a preliminary session may be immediately before notification of a client device of success of authentication.

In the first and the second low-speed communication system selection processes, a preliminary session may be established. The communication system selectable by the first and the second low-speed communication system selection processes uses the low frequency band. It is accordingly unlikely to cause abrupt interruption of communication, compared with the 60 MHz communication. The embodiment accordingly adopts the method of not establishing a preliminary session in these processes. The method of establishing a preliminary session even in these processes, however, more effectively reduces the possibility of interruption of communication.

The first and the second low-speed communication system selection processes are directed to find an available communication system by stepwise regression. The sequence of determining the availability of each communication system may thus be changed in any of various ways. For example, the first low-speed communication system selection process may proceed to step S420 in response to YES at step S415 and to step S437 in response to NO at step S415. This enables the access point 20 to select a different frequency of radio wave used for communication with the cradle 10 from the frequency of radio wave used for communication with the client device. Such selection reduces the possibility of interference of the two radio waves. This process may be performed by a third system communication module, which may be implemented by execution of a specific program by the CPU 110. For example, when the radio wave used for communication with the client device is 11n (2.4 GHz), 11n (5 GHz) may be selected as the radio wave used for communication with the cradle 10.

When determining the RSSI of 11ac as the medium level at step S340, the communication system selection process may subsequently determine the RSSI of 11n and determine whether communication by 11n is to be conducted, based on the result of the RSSI determination. For example, the first low-speed communication system selection process may be performed, instead of step S500.

A different system from that of the embodiment may be employed for wireless power supply: for example, magnetic resonance system, electric field coupling system or radio wave receiving system. These systems individually have different power supply distances. It is preferable to adequately combine the communication systems according to their power supply distances, as the subject of determination based on the availability of wireless power supply (60 GHz communication according to the embodiment).

The 60 GHz communication may employ a communication system conforming to the IEEE802.11 standard (e.g., 11ad) or may employ a communication system not conforming to this standard.

The communication system is not limited to those conforming to the IEEE802.11 standard but may be any of other currently-available communication systems or any of communication systems available in the future.

The connection system of the home gateway to the Internet may be the USB system.

The determination of whether or not wireless power supply is performed may be performed differently from that of the embodiment. The determination may not be based on the information obtained by the cradle by communication.

In the above embodiments, at least part of the software configuration may be replaced by hardware configuration, while at least part of the hardware configuration may be replaced by software configuration.

The communication device according to the first aspect includes: an electric charger configured to enable power supply or power reception to or from other device located in a shorter distance than a coverage distance of wireless communication by a first communication system; a communication preparatory module configured to start a preparation for wireless communication by a second communication system, which has a longer coverage distance than the coverage distance of wireless communication by the first communication system, when currently-active power supply or power reception to or from the other device is interrupted during selection of the first communication system for wireless communication with the other device; and a communication module configured to start wireless communication by the second communication system, in place of the first communication system, by utilizing the preparation by the communication preparatory module. The communication device of the first aspect increases the possibility of shortening the time when communication is interrupted. More specifically, the communication device of the first aspect starts the preparation for wireless communication by the second system, on interruption of the power supply or power reception. Starting the wireless communication by the second system by utilizing the preparation increases the possibility of shortening the time when communication is interrupted.

In the communication device of the first aspect, the communication module may start the wireless communication by the second communication system, when signal strength of the wireless communication by the first communication system decreases below a reference value. The reference value may be provided as a value allowing wireless communication. This configuration enables the switchover to the wireless communication to the second system, while the wireless communication by the first system is still enabled, thus increasing the possibility that communication is not interrupted.

The communication device of the first aspect may further include: a first system communication preparatory module configured to start a preparation for wireless communication by the first communication system, when the communication module starts the wireless communication; and a first system communication module configured to start wireless communication by the first communication system, in place of the second communication system, by utilizing the preparation by the first system communication preparatory module, when the signal strength of the wireless communication by the first communication system increases to or above the reference value. This configuration enables wireless communication by the first system, when the wireless communication by the first system is unlikely to be interrupted.

In the communication device of the first aspect, the electric charger may perform the power supply or power reception by wireless power supply allowed for other device that is located in a shorter distance than a maximum of the coverage distance of wireless communication by the first communication system. This configuration does not require determination of whether or not “other device is located in a shorter distance than a maximum of the coverage distance of wireless communication by the first communication system” by any other method.

In one application of the communication device of the first aspect, the other device may be an access point that is capable of making wireless communication with a client device. The communication device of the first aspect may further include a third system communication module configured to preferentially select a communication system that is unlikely to interfere with wireless communication between the client device and the access point and conduct communication by the selected communication system, when communication is not conducted by the first communication system or the second communication system. In another application, the communication device may be an access point that is capable of making wireless communication with a client device. The communication device of the first aspect may further include a third system communication module configured to preferentially select a communication system that is unlikely to interfere with wireless communication between the client device and the access point and conduct communication by the selected communication system, while communication is not conducted by the first communication system or the second communication system. These configurations facilitate avoidance of interference of wireless communication. The communication system that is unlikely to interfere may be, for example, a communication system using a different frequency band.

According to a second aspect, there is provided a communication system including two communication devices. In the communication system of the second aspect, when a distance between the two communication devices is shorter than a maximum of a coverage distance of wireless communication by a first communication system, the two communication devices may enable power supply from one communication device having power supply capability out of the two communication devices to the other communication device. When the power supply is interrupted during wireless communication by the first communication system, the two communication devices may start a preparation for wireless communication by a second communication system that has a longer coverage distance than the coverage distance of wireless communication by the first communication system. The two communication devices may start wireless communication by the second communication system, in place of the first communication system, by utilizing the preparation.

The communication system of the second aspect has the similar functions and advantageous effects to those of the communication device of the first aspect. Any of the various embodiments adopted for the communication device of the first aspect may also be applied to the communication devices included in the communication system of the second aspect.

According to a third aspect, there is provided a communication method of causing two communication devices to make communication with each other. In the communication method of the third aspect, the two communication devices may enable power supply from one communication device having power supply capability out of the two communication devices to the other communication device, when a distance between the two communication devices is shorter than a maximum of a coverage distance of wireless communication by a first communication system. The two communication devices may start a preparation for wireless communication by a second communication system that has a longer coverage distance than the coverage distance of wireless communication by the first communication system, when the power supply is interrupted during wireless communication by the first communication system. The two communication devices may start wireless communication by the second communication system, in place of the first communication system, by utilizing the preparation.

The communication method of the third aspect has the similar functions and advantageous effects to those of the communication device of the first aspect. Any of the various embodiments adopted for the communication device of the first aspect may also be applied to the communication method of the third aspect.

The disclosure is not limited to the above aspects or embodiments but may be implemented by any of various other aspects: for example, a program of enabling the communication method described above or a non-transitory storage medium in which such a program is stored.

What is claimed is:

1. A communication device, comprising:
an electric charger configured to perform a power supply operation with another device located at a shorter distance than a coverage distance of wireless communication by a first communication system, the power supply operation including providing a power supply to, or receiving a power supply from, the another device; and
circuitry configured to
start preparation for wireless communication by a second communication system, which has a larger coverage distance than the coverage distance of wireless communication by the first communication system, when a currently-active power supply operation is interrupted during selection of the first communication system for wireless communication with the another device; and
start wireless communication by the second communication system, in place of the first communication system, based on the preparation for wireless communication by the second communication system.

2. The communication device according to claim 1, wherein
the circuitry is further configured to start the wireless communication by the second communication system when a signal strength of the wireless communication by the first communication system decreases below a reference value.

3. The communication device according to claim 2, wherein
the reference value is a value at which communication by the first communication system can still be performed.

4. The communication device according to claim 1, wherein the circuitry is further configured to:
start preparation for wireless communication by the first communication system when wireless communication by the second wireless communication is started; and
start wireless communication by the first communication system, in place of the second communication system based on the preparation for wireless communication by the first communication system, when a signal strength of the wireless communication by the first communication system is equal to or greater than the reference value.

5. The communication device according to claim 1, wherein
the electric charger performs the power supply operation by wirelessly providing the power supply to, or receiving the power supply from, the another device only when the another device is located at a shorter distance than a maximum of the coverage distance of wireless communication by the first communication system.

6. The communication device according to claim 1, wherein
the another device is an access point configured to perform wireless communication with a client device, and
the circuitry is further configured to preferentially select a communication system that is unlikely to interfere with wireless communication between the client device and the access point, and conduct communication by the selected communication system when communication is not conducted by the first communication system or the second communication system.

7. The communication device according to claim 1, wherein
the communication device is an access point configured to perform wireless communication with a client device, and
the circuitry is further configured to preferentially select a communication system that is unlikely to interfere with wireless communication between the client device and the access point, and conduct communication by the selected communication system, while communication is not conducted by the first communication system or the second communication system.

8. A communication system comprising:
a first communication device configured to supply power to a second communication device when a distance between the first and second communication devices is shorter than a maximum of a coverage distance of wireless communication by a first communication system, wherein
the first and second communication devices are configured to start preparation for wireless communication by a second communication system that has a larger coverage distance than the maximum of the coverage distance of wireless communication by the first communication system when the power supply from the first communication device to the second communication device is interrupted during wireless communication by the first communication system, and
the first and second communication devices are configured to start wireless communication by the second communication system, in place of the first communication system, based on the preparation for wireless communication by the second communication system.

9. The communication system according to claim 8, wherein
the first and second communication devices are configured to start the wireless communication by the second wireless communication system when a signal strength of the wireless communication by the first communication system decreases below a reference value.

10. The communication system according to claim 9, wherein
the reference value is a value at which communication by the first communication system can still be performed.

11. The communication system according to claim 8, wherein
the first and second communication devices are configured to start a preparation for wireless communication by the first communication system when the wireless communication by the second wireless communication is started, and
the first and second communication devices are configured to start wireless communication by the first communication system, in place of the second communication system, based on the preparation for wireless communication by the first communication system, when the signal strength of the wireless communication by the first communication system is equal to or greater than the reference value.

12. The communication system according to claim 8, wherein
the first communication device is configured to wirelessly supply the power supply to the second communication device when the second communication device is located in a shorter distance than the maximum of the coverage distance of wireless communication by the first communication system.

13. The communication system according to claim 8, wherein
the second communication device is an access point that is configured to perform wireless communication with a client device, and
the first and second communication devices are configured to preferentially select a communication system that is unlikely to interfere with wireless communication between the client device and the access point and conduct communication by the selected communication system while communication is not conducted by the first communication system or the second communication system.

14. A communication method comprising:
supplying power from a first communication device having power supply capability to a second communication device when a distance between the first and second communication devices is shorter than a maximum of a coverage distance of wireless communication by a first communication system;
starting, by the first and second communication devices, preparation for wireless communication by a second communication system that has a larger coverage distance than the maximum coverage distance of wireless communication by the first communication system, when the power supply is interrupted during wireless communication by the first communication system; and
starting, by the first and second communication devices, wireless communication by the second communication system, in place of the first communication system based on the preparation for wireless communication by the second communication system.

15. The communication method according to claim 14, further comprising:
starting, by the first and second communication devices, wireless communication by the second communication system when a signal strength of the wireless communication by the first communication system decreases below a reference value

16. The communication method according to claim 15, wherein
the reference value is a value at which communication by the first communication system can still be performed.

17. The communication method according to claim 14, further comprising:
starting, by the first and second communication devices, preparation for wireless communication by the first communication system when the wireless communication by the second communication system is started; and
starting, by the first and second communication devices, wireless communication by the first communication system, in place of the second communication system, based on the preparation for wireless communication by the first communication system, when a signal strength of the wireless communication by the first communication system is greater than or equal to the reference value.

18. The communication method according to claim 14, wherein
the supplying includes supplying the power from the first communication device to the second communication device when the second communication device is located at a shorter distance than the maximum of the coverage distance of wireless communication by the first communication system.

19. The communication method according to claim 14, wherein
the second device is an access point configured to perform wireless communication with a client device, and
the communication method further comprises:
preferentially selecting, by the first and second communication devices, a communication system that is unlikely to interfere with wireless communication between the client device and the access point; and
conducting, by the first and second communication devices, communication by the selected communication system, while communication is not conducted by the first communication system or the second communication system.
